(19) United States
(12) Patent Application Publication
(10) Pub. No.: US 2024/0018787 A1
(43) Pub. Date: Jan. 18, 2024

(54) RETRACTABLE ACCESS MEANS WITH COLLAPSIBLE HANDRAIL ASSEMBLY

(71) Applicant: Barjoh Pty Ltd, Oakford (AU)

(72) Inventor: Nathan John ELLEMENT, Oakford (AU)

(73) Assignee: Barjoh Pty Ltd, Oakford (AU)

(21) Appl. No.: 18/356,982

(22) Filed: Jul. 21, 2023

Related U.S. Application Data
(63) Continuation of application No. PCT/AU22/50028, filed on Jan. 21, 2022.

(30) Foreign Application Priority Data
Jan. 22, 2021 (AU) 2021900144

(51) Int. Cl. E04F 11/06; B60R 3/02; E06C 5/04; E06C 5/36

(52) U.S. Cl. CPC E04F 11/062; B60R 3/02; E06C 5/04; E06C 5/36

(57) ABSTRACT

An access system (10) for a vehicle, equipment or installation, the access system (10) including at least one section having multiple treads/steps (56), a retraction mechanism with at least one actuator (28), the retraction mechanism arranged to retract and allow deployment of the access means (12), and at least one handrail assembly (32), the at least one handrail assembly (32) being pivotably connected to the access means (12) such that the handrail assembly (32) collapses relative to the at least one section for stowage and extends to provide a handrail for supporting a user when the access means (12) is deployed.

### CROSS-REFERENCE TO RELATED APPLICATIONS

This application is a continuation of PCT Application Number PCT/AU2022/050028 filed Jan. 21, 2022, which claims priority to Australian Patent Application Number 2021900144 filed Jan. 22, 2021, which is incorporated herein by reference in its entirety.

### TECHNICAL FIELD

The present invention relates to retractable access systems.

One or more non-limiting particular forms of the present invention relates to retractable access systems for earthmoving and construction vehicles.

A retractable access system includes an access means (such as a stair or ladder) deployable from a retracted position and retractable from a deployed position.

The term ‘retractable’ or ‘deployable’ includes at least a pivoting motion of the access means (stair or ladder) and may include folding/unfolding or nesting/un-nesting of sections of the access means relative to one another.

### BACKGROUND OF THE INVENTION

Systems using a deployable/retractable access means can be provided on large earth moving and construction vehicles. For example, deployable/retractable access means (e.g. stairs or inclined ladder) can be provided so that the vehicle operator can step up into the cab without climbing a vertical ladder that may have a negative inclination if the equipment is not otherwise parked on level ground.

It will be appreciated that the access means can be deployed from a retracted position (the vehicle being able to move safely when the access means is retracted) and can be retracted from a deployed position (e.g. when access to/from the vehicle is required and the vehicle is stationary).

Once the operator is on the machine, the access means (stair or ladder) is retracted so that the access means is not hanging downwards and/or outwards and the ground clearance of the machine is increased, thus minimizing the probability of the access means being damaged by contacting rocks when the machine is in motion.

The access means also needs to be retracted so that other personnel cannot climb up onto the machine without the operator's knowledge. Should a person be on the access means without the operator's knowledge, the possibilities for injury to that person are numerous. The possible injuries can range from overbalancing the person, to crushing or trapping the person between the moving parts/wheels of the equipment and the adjoining bodywork of the equipment.

The systems used for retracting the access means can vary but generally they rely on either an electric or hydraulic system that is manually actuated by the operator.

Vehicles, in particular, can have limited storage space for a retracted access means. Also, deployment or retraction motions of a full-length access means can cause clearance issues with parts of the vehicle and/or infrastructure/personnel adjacent the vehicle. Such clearance issues can also be present for non-vehicular applications of deployable/retractable access means.

Access systems are safer for personnel to use when a handrail is present. The handrail gives personnel protection and steadying support when ascending or descending the access means. A handrail may be required to meet national or international safety or operational standards, such as ISO (International Organization for Standardization) or AS (Australian Standards).

However, the space required by a handrail, and the need to have the handrail deploy and retract with the access means creates technical, robustness and reliability challenges when developing a handrail suitable for a retractable access system.

Handrails on known access systems for mining and heavy vehicles are physically connected to the vehicles and to the access means. Consequently, complex structural folding and telescoping connections and geometries are required to compensate for the positional and angular relationship changes between the handrail and the access means.

With the aforementioned in mind, it is an object of the present invention to provide a retractable access system that includes a collapsible handrail arrangement mounted to the access means of the system and that retracts and deploys in concert with the access means and operated by a retraction mechanism of the access means.

It is to be understood that, if any prior art is referred to herein, such reference does not constitute an admission that the prior art forms a part of the common general knowledge in the art, in Australia or any other country.

### SUMMARY OF THE INVENTION

With the aforementioned in mind, an aspect of the present invention provides an access system for a vehicle, equipment or installation, the access system including at least one section having multiple treads/steps, a retraction mechanism to retract and allow deployment of the access means, and at least one handrail assembly, the at least one handrail assembly being pivotably connected to the access means such that the handrail assembly collapses relative to the at least one section for stowage and extends to provide a handrail for supporting a user when the access means is deployed.

When a handrail is mounted connected to the side of the vehicle, as with known access systems, they have the need for telescoping rails to stop the handrails folding overcentre. If the handrails fold overcentre, they cannot readily be re-extended from their collapsed position unless a complex joint and telescoping arrangement is provided to compensate for the overcentre problem that arises because the handrail has been mounted connected to the vehicle.

One or more forms of the present invention overcomes such limitations by having the handrail assembly mounted to the access means and operated to collapse/extend by means of the retraction mechanism.

Advantageously, a linkage arrangement extending from and functionally connected to the retraction mechanism to the handrail/handrail baluster avoids the need for connection of the handrail to the vehicle, equipment or installation.

The access means, retraction mechanism and collapsible handrail assembly can be provided as an assembly for mounting to the vehicle, equipment or installation without needing the handrail to be connected directly thereto or the complex joints and telescoping arrangements.

A link arrangement connecting the at least one actuator to the baluster to which the handrail is pivotably attached is configured such that the overcentre problem is avoided.

The at least one handrail assembly may be operated to collapse and extend relative to the at least one section by mechanical connection to the retraction mechanism.

The mechanical connection may be provided via a pivotable link arrangement. The pivotable link arrangement may include a link (linkage) between the respective handrail assembly and part of the retraction mechanism.

Collapse and/or extension of the at least one handrail assembly may be actuated by operation of at least one actuator for retracting and/or deploying the access means.

The at least one actuator can include at least one hydraulic actuator, at least one pneumatic actuator and/or at least one electric actuator.

The link (linkage) arrangement between the handrail assembly and the retraction mechanism can include the link arrangement being connected to, or part of, a baluster of the respective handrail assembly.

It will be appreciated that a baluster refers to an upright (when erected/extended) connected directly or indirectly between the respective handrail and a stringer extending along a side of the section to support steps/treads of the section. The baluster or balusters may be pivotably connected relative to the handrail and the stringer/side, such as by pivot connection to brackets or direct pivot connections.

The access means and a baluster connected between the actuator and the handrail preferably rotate in the same direction relative to the mount/vehicle, equipment, installation during retraction and deployment.

The baluster connected to the actuator preferably rotates fewer degrees or at a slower rate than the access means during retraction or deployment.

During retraction, the access means preferably rotates upwards and the respective handrail collapses toward the access means, whilst both the access means and the baluster connected to the actuator both rotate in the same direction relative to the mount.

During deployment, the access means preferably rotates downwards and the respective handrail is moved away from the access means, whilst both the access means and the baluster connected to the actuator both rotate in the same direction relative to the mount.

A baluster may be functionally connected to the at least one actuator of the retraction mechanism and to the handrail.

The baluster may be arranged and configured to rotate (via at least one pivot connection) relative to the mount in the same direction as the stair rotates during retraction or deployment of the access means.

The access means and the baluster may be arranged and configured to rotate (via at least one respective pivot connection) in the same direction relative to the mount/vehicle, equipment, installation during retraction and deployment.

A baluster may be functionally connected to the at least one actuator is configured to rotate fewer degrees or at a slower rate than the access means during retraction or deployment.

During retraction, the access means is arranged and configured to rotate upwards and the respective handrail collapses toward the access means, whilst both the access means and the baluster both rotate in the same direction relative to the mount.

During deployment, the access means is arranged and configured to rotate downwards and the respective handrail is moved away from the access means, whilst both the access means and the baluster both rotate in the same direction relative to the mount.

The baluster preferably includes a member extending between a connection to the handrail and a connection to the access means.

The connection to the handrail and/or the connection to the access means may include a respective pivot connection.

The baluster is preferably connected to a link arrangement pivotably connected to the at least one actuator.

The baluster may be functionally connected to at least one further baluster by the handrail and/or at least one midrail. A midrail relates to a safety rail extending between at least two adjacent balusters and spaced from the handrail and the access means.

Distance between a main pivot connecting the access means to a mount and connection of the at least one actuator to the access means is greater than a distance between a connection of the link arrangement to the access means and to the at least one actuator.

It will be appreciated that the term ‘baluster’ refers to a element/member (such as an elongate member) providing physical connection (direct or indirect) between the respective handrail and the access means, similar to an upright between a handrail and a stringer of traditional fixed stairs, though in this invention the baluster is pivotably connected relative to the access means so that the baluster is upright when deployed and pivots towards the access means during retraction (e.g. for stowage of the access means with the handrail assembly collapsed down).

The access means may rotate through an angle greater than the angle of rotation of at least one baluster/handrail assembly between fully deployed and fully retracted positions of the access means. Geometry and length of one or more links/linkages, such as spacing between and/or position of pivot connections can be arranged and configured to generate the required angular values, for example, such as shown in the accompanying drawings.

The access means can be retracted or deployed through an overall rotation angle of up to 175° between fully deployed and fully retracted positions, preferably up to 160°, more preferably up to 150° and yet more preferably up to around 135°. The respective angle can be determined relative to the mount to which the access means is pivoted.

At least one baluster, preferably the actuated baluster connected to the retraction mechanism, of the handrail assembly connected for rotation relative to the access means rotates through an angle equivalent to between 15% and 40%, preferably between 20 and 35, of the overall angle of rotation of the access means between fully deployed and fully retracted positions.

The handrail assembly can be rotated through a rotation angle of between 15% and 40%, preferably between 20% and 35% of the angle of rotation of the access means.

One or more midrails may extend between successive balusters. The one or more midrails may be pivotably connected at each end thereof to the respective balusters.

The access system may include multiple sections, each having a number of treads/steps. Preferably at least a first and a second said section are pivotably connected, such as for compact stowage.

A link arrangement may be provided that transfer motion between the first and the second sections. The linkage arrangement may include a first transfer link and a second transfer link, pivotably connected to each other. At least one of the transfer links may be connected to a midtrial or baluster of the second section.

Retraction operation of the retraction mechanism can cause a distal (lower) end of a first (upper) said section to raise and the handrail assembly associated with the first section to commence collapsing relative to the first section.

When stowed, the multiple sections may be adjacent one another.

Another aspect of the present invention provides a method of retracting an access system incorporating at least one collapsible handrail assembly includes the steps of operating a retraction mechanism having an actuator to drive retraction of an access means, the retraction mechanism driving collapse of the handrail assembly relative to the access means.

Retraction of the access means may include pivoting of a second section of the access means relative to a first section of the access means, each said section including a number of treads/steps of the access means.

The first section may include a first handrail assembly and the second section may include a second handrail assembly, and retraction of the access means collapses the first and the second handrail assembly.

Collapse of the second handrail assembly is preferably driven by mechanical connection of the second handrail assembly to the first section and/or to the first handrail assembly.

The linkage arrangement may transfer motion to the handrail assembly of the second section, driving the handrail assembly associated with the second section to collapse relative to the second section.

It will be appreciated that deployment of the access means can be a reversal of the steps of retraction and use of the retraction mechanism.

Power for the at least one actuator may be provided by vehicle, equipment or installation systems, such as on-board hydraulic, pneumatic or electric supply. Alternatively, dedicated power supply can be provided.

Collapse of the second handrail assembly may be driven by mechanical connection of the second handrail assembly to the first section and/or to the first handrail assembly.

The retraction mechanism may be arranged and configured to operate between the access means and a mount connecting the access means to the vehicle, equipment or installation.

The at least one handrail assembly is preferably pivotably mounted to the access means.

The access means may be mounted to a mount attached to the vehicle, equipment or installation, and the retraction mechanism may be connected to operate between the mount and the access means.

A baluster may be functionally connected to the at least one actuator of the retraction mechanism and to the handrail.

The baluster may be rotated relative to the mount in the same direction as the access means is rotated during retraction or deployment of the access means.

The access means and the baluster may be rotated in the same direction relative to the mount/vehicle, equipment, installation during retraction and deployment.

wherein the baluster functionally connected to the at least one actuator is rotated fewer degrees or at a slower rate than the access means during retraction or deployment.

During retraction, the access means may be rotated upwards and the respective handrail collapses toward the access means, whilst both the access means and the baluster both rotate in the same direction relative to the mount.

During deployment, the access means may be rotated downwards and the respective handrail is moved away from the access means, whilst both the access means and the baluster are both rotated in the same direction relative to the mount.

The baluster may include a member extending between a connection to the handrail and a connection to the access means. The connection to the handrail and/or the connection to the access means includes a respective pivot connection.

The baluster may be connected to a link arrangement pivotably connected to the at least one actuator. The baluster and the link arrangement may be one component, such as a continuous member/element, preferably of metal.

The baluster may be functionally connected to at least one further baluster by the handrail and/or at least one midrail.

A distance between a main pivot connecting the access means to a mount and connection of the at least one actuator to the access means may be greater than a distance between a connection of the link arrangement to the access means and to the at least one actuator. Such differences in leverage distance enables the access means to rotate angularly further and/or at a greater rate than the baluster (and therefore retraction of the access means is through a greater angle than the collapse of the handrail assembly).

### BRIEF DESCRIPTION OF THE FIGURES

One or more embodiments or examples of the present invention will hereinafter be described with reference to the accompanying Figures, in which:

FIGS. 1A to 1D show stages of retraction (the reverse order 1D to 1A showing stages of deployment) of a two section access means with collapsible handrails according to an embodiment of the present invention.

FIGS. 2A to 2E show stages of retraction (the reverse order 2E to 2A showing stages of deployment) of an access means with collapsible handrail according to a further embodiment of the present invention.

It will be appreciated that the access system is typically powered to retract by a hydraulic, pneumatic or electric drive arrangement.

Likewise, the access means of the access system mounts to a vehicle or other equipment/installation requiring user access/egress via the access means. A diagrammatic representation of the vehicle, equipment or installation is provided in the drawings by way of general example of the mounting of the access means.

### DESCRIPTION OF PREFERRED EMBODIMENT(S)

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

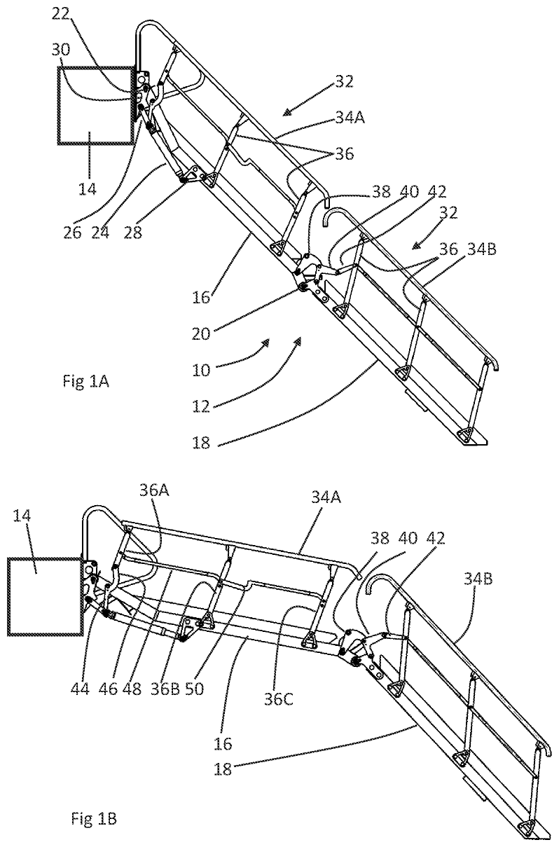

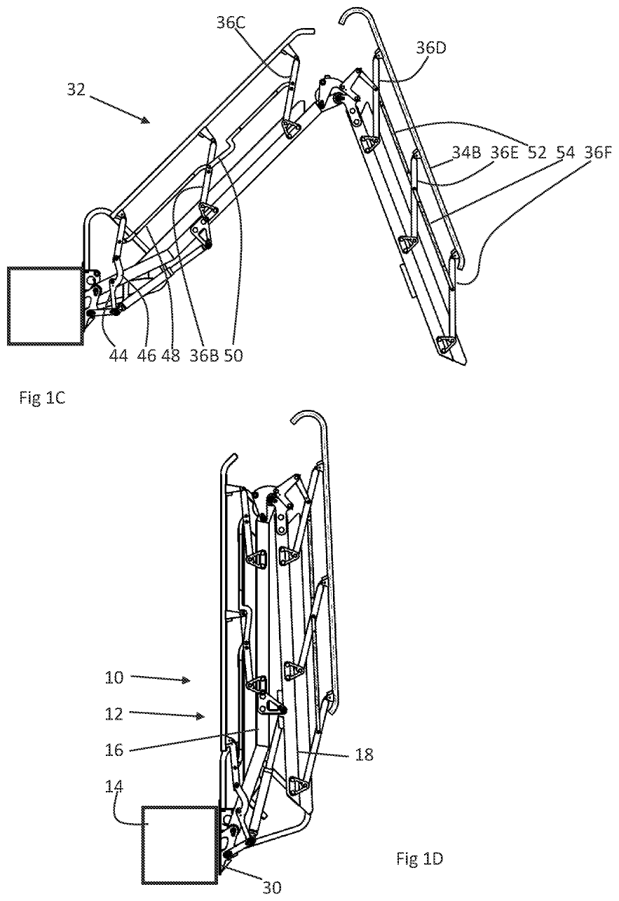

FIGS. 1A to 1D show stages of retraction (the reverse order 1D to 1A showing stages of deployment) of a two section access means with collapsible handrails according to an embodiment of the present invention.

FIG. 1A shows the access means 12 fully deployed. FIG. 1B shows the access means partially retracted. FIG. 1C shows the access means further retracted. FIG. 1D shows the access means fully retracted.

An access system 10 includes an access means 12 that mounts to a vehicle, equipment or installation 14.

The access means can include a single section incorporating fixed or folding steps/treads or multiple sections arranged and configured to pivot/hinge relative to one another. The sections may fold together or nest together when retracting/retracted.

The section or multiple sections of the access means include(s) multiple steps/treads 56 for use in perambulatorily ascending or descending on the access means

In the example shown in FIGS. 1A to 1D, the access means is provided as a two section access means (e.g. stairs) incorporating a first (upper when deployed) section 16 and a second (lower when deployed) section 18.

The first section 16 and second section 18 are connected together by a at least one pivot arrangement 20. The pivot arrangement 20 allows the first and second section to fold relative to one another during retraction and deployment.

The access means mounts to a vehicle, equipment or installation 14. A main pivot arrangement 22 allows pivoting movement during retraction and deployment of the access means 12.

At least one actuator 24 (e.g. hydraulic, pneumatic, electric) connects between a link 26 and an actuator bracket 28. The link 26 connects the actuator to a main bracket 30 mounted to the vehicle, equipment or installation. A collapsible handrail assembly 32 is pivotably mounted to each section 16, 18.

The respective handrail assembly 32 includes a handrail 34 (34A, 34B) pivotably connected via one or more balusters 36 (36A, 36B, 36C). Each baluster is pivotably connected to a respective handrail and to the respective section of the access means.

First 38 and second 40 transfer arms are pivotably connected. The first transfer arm 38 is also pivotably connected to a lower end of the first section 16. The second transfer arm 40 is pivotably connected to an upper end of the second section 18.

A transfer link 42 transfers motion from the second transfer arm 40 to the handrail assembly 32 of the second section 18.

During retraction of the exemplary multi-section access means, as the first (upper) section lifts via action from the actuator 24, pivoting from the pivot at the upper end (mount end) and the second section commences folding in under the first section.

Motion is transferred via a link member 44 connected to a baluster link 46 connected to the upper baluster 36A. The upper baluster 36A is pivotably connected to the handrail 34A and also pivotably connected to a first midrail 48.

Motion is transferred via pivotable connections to the second baluster 36B and transferred to a third baluster 36C via a second midrail 50.

Motion is transferred from the transfer link 42 to the upper baluster 36D of the second section 18. A first midrail 52 of the second section 18 transfers motion to the middle baluster 36E, and a second midrail 54 transfers motion to the lower baluster 36F. The handrail 34B is also pivotably connected to the balusters and thereby in pivotable connection with the midrails and with the transfer link 42.

As shown in FIG. 1D, the multi-section access means 12 retracts to a stowage position with the first and second section folded together. The handrail assemblies are arranged such that the handrails 34 (34A, 34B) collapse down to reduce stowage space, create greater clearance around the vehicle, equipment, installation and reduce leverage (bounce) and associated wear on the main pivot that would otherwise be present in a full length retracted access means of the same overall length.

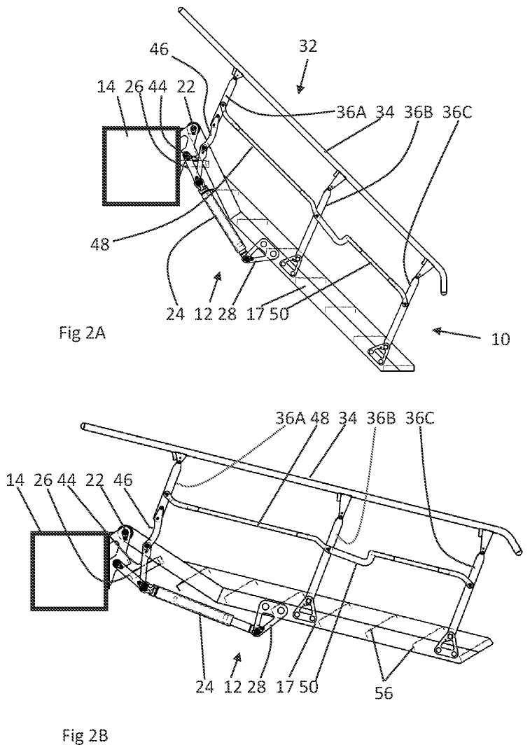

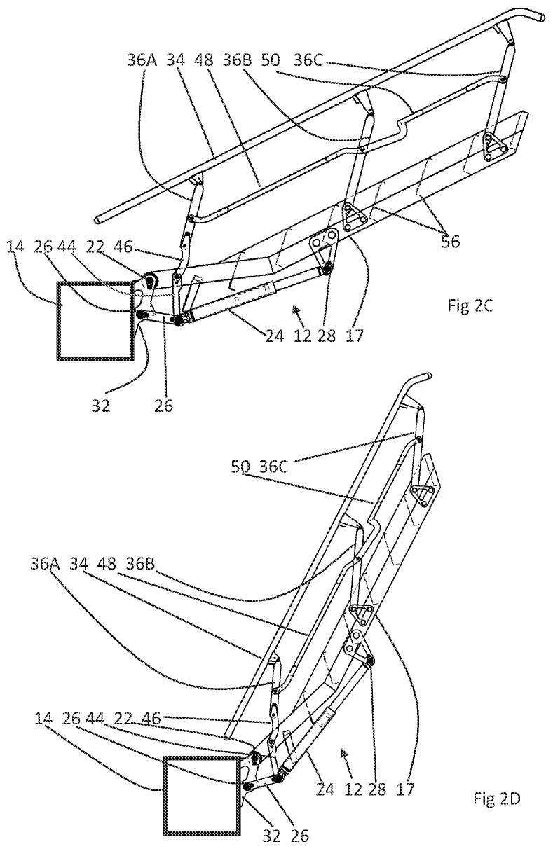

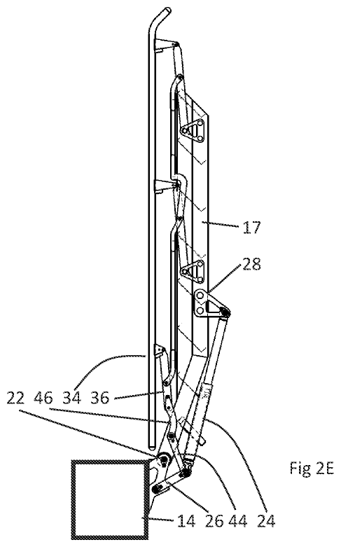

FIGS. 2A to 2E show stages of retraction (the reverse order 2E to 2A showing stages of deployment) of an access means with collapsible handrail according to a further embodiment of the present invention.

A single section 17 access means 12 of an access system 10 according to a further embodiment of the present invention is pivotably mounted to a vehicle, equipment or installation 14 via a main pivot arrangement 22. The main pivot arrangement preferably has a main pivot axis.

A link 26 connects to end of an actuator 24. An opposite end of the actuator is connected to an actuator bracket 28. The actuator can be hydraulically, pneumatically or electrically powered.

The actuator 28 may be or include a single acting or double acting ram. For a single acting ram, actuation can extend the ram, causing the access means to raise (retract). Lowering can be by gravity, with optional pressure/flow control out of the ram to dampen/control the deployment motion/speed.

Motion is transferred via a link member 44 connected to a baluster link 46 connected to the upper baluster 36A. The upper baluster 36A is pivotably connected to the handrail 34A and also pivotably connected to a first midrail 48.

Motion is transferred via pivotable connections to the second baluster 36B and transferred to a third baluster 36C via a second midrail 50.

The handrail 34 is pivotably connected to the balusters 36A, 36B, 36C, and thereby to the section 17 of the access means and the midrails 48, 50.

As the actuator extends (see FIG. 2B) the distal (lower) end of the section raises. The link arm 44 and baluster link 46 pivot about a pivot connection to the access means. As the section raises, the handrail assembly 32 collapses.

Further extension of the actuator (see FIG. 2C) further collapses down the handrail assembly 32 as the section 17 of the access means 12 raises (retracts).

The access means 12 retracts upwards to an upright stowage position (see FIG. 2E) with the handrail assembly collapsed for storage.

During retraction, the at least one actuator drives the access means to rotate upwards relative to the mount/vehicle, equipment, installation to which the access means is attached. The handrail assembly is mounted to the access means. The handrail assembly, through connection of the baluster(s) to the at least one actuator is driven to collapse towards the access means whilst rotating in the same direction as the access means.

It will be appreciated that, during retraction, the handrail assembly rotates at a slower rate or through lesser angular degree of rotation relative to the access means, such that, whilst both rotate upwards relative to the mount, they close together, and the physical link connection between the handrail assembly and the at least one actuator, and the pivotable connections of the handrail to the balusters (and any midrails) enable the handrail assembly to collapse down (and to expand out during the reverse action of deployment).

Avoiding a direct/fixed connection between the handrail assembly and the vehicle, equipment, installation avoids the need for complex pivot and telescoping connections between components of the handrail assembly.

There is also benefit in the access system being self-contained in the sense that the handrail assembly, access means and the at least one actuator can be provided as a complete system without needing connection to the vehicle, equipment or installation other than via the mount and any power supply to the at least one actuator.

The access means can be retracted or deployed through an overall rotation angle of up to 175° between fully deployed and fully retracted positions, preferably up to 160°, more preferably up to 150° and yet more preferably up to around 135°.

At least one baluster, preferably the actuated baluster connected to the retraction mechanism, of the handrail assembly connected for rotation relative to the access means rotates through an angle equivalent to between 15% and 40% of the overall angle of rotation of the access means between fully deployed and fully retracted positions.

For an exemplar vehicle application, the angle of rotation of the access means is 135° and the baluster rotates around 30.5% (approximately 47.25 degrees) of the rotation of the access means

The handrail assembly can be rotated through a rotation angle of between 15% and 30% of the angle of rotation of the access means.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

We claim:

1. An access system for a vehicle, equipment or installation, the access system including at least one section having multiple treads/steps, a retraction mechanism with at least one actuator, the retraction mechanism arranged to retract and allow deployment of the access means, and at least one handrail assembly, the at least one handrail assembly being pivotably connected to the access means such that the handrail assembly collapses relative to the at least one section for stowage and extends to provide a handrail for supporting a user when the access means is deployed.

2. The access system of claim 1, wherein:
collapse and/or extension of the at least one handrail assembly is actuated by operation of the at least one actuator for retracting and/or deploying the access means; and
the at least one actuator includes at least one hydraulic actuator, at least one pneumatic actuator and/or at least one electric actuator.

3. The access system of claim 1, wherein:
the at least one handrail assembly is operated to collapse and extend relative to the at least one section by mechanical connection to the retraction mechanism;
the mechanical connection is via a pivotable link arrangement;
the pivotable link arrangement includes a link between the respective handrail assembly and part of the retraction mechanism; and
the link between the handrail assembly and the retraction mechanism includes the link arrangement being connected to, or part of, at least one baluster of the respective handrail assembly.

4. The access system of claim 3, wherein:
one or more midrails extends between successive said balusters; and
the one or more midrails is pivotably connected at each end thereof to the respective baluster(s).

5. The access system of claim 1, including multiple sections, each having a number of treads/steps, wherein:
at least a first section and a second section are pivotably connected together;
at least one link arrangement is provided to transfer motion between the first section and the second section;
the linkage arrangement includes a first transfer link and a second transfer link, pivotably connected to each other;
at least one of the transfer links is connected to a midrail or baluster of the second section;
the linkage arrangement is arranged and configured to transfer motion to the handrail assembly of the second section; and
when stowed, the multiple sections are adjacent one another.

6. The access system of claim 1, wherein:
the at least one handrail assembly is mounted to the access means;
the access means is mounted to a mount attached to the vehicle, equipment or installation; and
the retraction mechanism is connected to operate between the mount and the access means.

7. The access system of claim 1, wherein a baluster is functionally connected to the at least one actuator of the retraction mechanism and to the handrail.

8. The access system of claim 7, wherein:
the baluster rotates relative to the mount in the same direction as the access means rotates during retraction or deployment of the access means;
the access means and the baluster rotate in the same direction relative to the mount/vehicle, equipment, installation during retraction and deployment; and
the baluster functionally connected to the at least one actuator is configured to rotate fewer degrees or at a slower rate than the access means during retraction or deployment.

9. The access system of claim 7, wherein, during retraction, the access means rotates upwards and the respective handrail collapses toward the access means, whilst both the access means and the baluster both rotate in the same direction relative to the mount.

10. The access system of claim 7, wherein, during deployment, the access means is configured to rotate downwards and the respective handrail is moved away from the access means, whilst both the access means and the baluster both rotate in the same direction relative to the mount.

11. The access system of claim 7, wherein:
the baluster includes a member extending between a connection to the handrail and a connection to the access means;
the connection to the handrail and/or the connection to the access means includes a respective pivot connection;
the baluster is connected to a link arrangement pivotably connected to the at least one actuator; and
the baluster is functionally connected to at least one further baluster by the handrail and/or at least one midrail.

12. The access system of claim 7, wherein a distance between a main pivot connecting the access means to a mount and connection of the at least one actuator to the access means is greater than a distance between a connection of the link arrangement to the access means and to the at least one actuator.

13. A method of retracting an access system incorporating at least one collapsible handrail assembly includes the steps of operating a retraction mechanism having an actuator to drive retraction of an access means, the retraction mechanism driving collapse of the handrail assembly relative to the access means.

14. The method of claim 13, wherein:
retraction of the access means includes pivoting of a second section of the access means relative to a first section of the access means, each of the first section and the second section including a number of treads/steps of the access means;
the first section includes a first handrail assembly;
the second section includes a second handrail assembly;
retraction of the access means collapses the first handrail assembly and the second handrail assembly;
collapse of the second handrail assembly is driven by mechanical connection of the second handrail assembly to the first section and/or to the first handrail assembly; and
the retraction mechanism operates between the access means and a mount connecting the access means to the vehicle, equipment or installation.

15. The method of claim 13, wherein a baluster is functionally connected to the at least one actuator of the retraction mechanism and to the handrail.

16. The method of claim 15, wherein:
the baluster is rotated relative to the mount in the same direction as the access means is rotated during retraction or deployment of the access means;
the access means and the baluster are rotated in the same direction relative to the mount/vehicle, equipment, installation during retraction and deployment;
the baluster functionally connected to the at least one actuator is rotated fewer degrees or at a slower rate than the access means during retraction or deployment;
during retraction, the access means rotates upwards and the respective handrail collapses toward the access means, whilst both the access means and the baluster both rotate in the same direction relative to the mount;
during deployment, the access means is rotated downwards and the respective handrail is moved away from the access means, whilst both the access means and the baluster are both rotated in the same direction relative to the mount;
the baluster includes a member extending between a connection to the handrail and a connection to the access means;
the connection to the handrail and/or the connection to the access means includes a respective pivot connection;
the baluster is connected to a link arrangement pivotably connected to the at least one actuator; and
the baluster is functionally connected to at least one further baluster by the handrail and/or at least one midrail.

17. The method of claim 15, wherein a distance between a main pivot connecting the access means to a mount and connection of the at least one actuator to the access means is greater than a distance between a connection of the link arrangement to the access means and to the at least one actuator.

18. The method of any one of claim 13, wherein the access means is retracted or deployed through an overall rotation angle of up to 175° between fully deployed and fully retracted positions, preferably up to 160°, more preferably up to 150° and yet more preferably up to around 135°.

19. The method of claim 18, wherein at least one baluster connected for rotation relative to the access means rotates through an angle equivalent to between 15% and 40%, preferably between 20% and 35%, of the overall angle of rotation of the access means between fully deployed and fully retracted positions.

20. The method of any one of claim 13, wherein the handrail assembly is rotated through a rotation angle of between 15% and 40%, preferably between 20% and 35%, of the angle of rotation of the access means.
